(19) United States
(12) Patent Application Publication
(10) Pub. No.: US 2026/0037515 A1
(43) Pub. Date: Feb. 5, 2026

(54) SYSTEM AND METHOD FOR SEMI-AUTOMATED ADJUDICATED RESOLUTION IN THE CONTEXT OF NON-DISPOSITIVE SCENARIOS FOR VARYING USE CASES

(71) Applicant: THE DUN AND BRADSTREET CORPORATION, Jacksonville, FL (US)

(72) Inventors: Dave Spingarn, Randolph, NJ (US); Anthony Phillip Pike, Didcot (GB); Anthony J. Scriffignano, West Caldwell, NJ (US); Michel Filippi, Banbury (GB); Lewis Anthony Utley, Arborfield (GB); Paul Anthony O'Neill, Rathfarnham (IE)

(73) Assignee: THE DUN AND BRADSTREET CORPORATION, Jacksonville, FL (US)

(21) Appl. No.: 19/265,136

(22) Filed: Jul. 10, 2025

Related U.S. Application Data
(60) Provisional application No. 63/669,540, filed on Jul. 10, 2024.

(51) Int. Cl. G06F 16/2455; G06F 16/215

(52) U.S. Cl. CPC G06F 16/2455; G06F 16/215

(57) ABSTRACT

A method for semi-automated adjudicated identity resolution comprising: seeking best match entity candidates via a core capabilities stage for the identity resolution wherein the core capabilities are called multiple times in parallel, providing differing subsets of the full inquiry indicia received from client, such that a large number of possible outcomes can be observed depending on which inquiry indica are used in combination with others; and assigning an initial outcome code for the resulting winner for each pass; wherein the initial outcome code may later be promoted or improved when considered in conjunction with the outcome of one or more other pass outcomes. Stewardship intent is monitored and, in the event an “accept” outcome is not initially found, the system recursively leverages the most positive results of prior attempts and generates additional passes in an effort to find a more acceptable outcome. Interim and eventual results are all experiential data and are captured for multiple uses including, but not limited to, tuning methods, input to AI methods for tuning, and informs downstream discovery and curation processes.

### CROSS-REFERENCED APPLICATION

This is a non-provisional application based on U.S. Provisional Application Ser. No. 63/669,540, entitled “System and Method for Semi-Automated Adjudicated Resolution in the Context of Non-Dispositive Scenarios for Varying Use Cases,” filed on Jul. 10, 2024, which is incorporated herein by reference thereto in its entirety.

### BACKGROUND

### 1. Field

A method for semi-automated adjudicated identity resolution comprising: seeking best match entity candidates via a core capabilities stage for the identity resolution for a single pass using enhanced core capabilities; and extending the core capabilities stage with an attribution stage, which assigns a multi-indicia assessment of the retrieved and evaluated candidates, by leveraging the granular indicia assessments; wherein the multi-indica assessments are grouped by related or similar yet distinct scenarios.

### 2. Discussion of the Background Art

Identity Resolution (IDR) uses input criteria to find the best candidates in its extensive database of entities. It uses proprietary algorithms to identify the best matches and returns those matches with detailed information about what criteria was used to find the match. See U.S. Pat. No. 7,392,240 (Scriffignano et al.), issued on Jun. 24, 2008, which is incorporated herein in its entirety by reference thereto.

### Identity Resolution Steps

1. Cleanse, Parse, and Standardize
2. Retrieve candidates
3. Evaluate and decide

Identity Resolution API, Batch Match, and High-Volume Match perform all 3 of these steps.

### Cleansing, Parsing, and Standardization

Cleansing, Parsing and Standardization maximizes the impact of the inquiry in identifying candidates.

### Cleanse

Remove extraneous characters.
Convert to standard abbreviations (e.g., N=North).
Replace vanity with standard city names (e.g., Westwood to Los Angeles).
Convert text versions of numbers to numeric equivalent.
Remove noise and low-value words (e.g., INC, CO).

### Parse

Segregate address components.
Correct street and city names.
Parse freeform text into logical subcomponents.
Generate latitude and longitude.

### Standardize

Remove plurals.
Standardize words and phrases.
Remove punctuation.
Correct spelling.
Format to postal standards.

Identity resolution is a capability critical to automated reconciliation of identified entity data to a pre-mastered universe. Emerging use cases in GenAI and Responsible AI require differing interpretation of certain facts. This variation in interpretation gives rise to multiple responsibilities, with many people reviewing the same decisions manually. This manual approach is not scalable.

The present disclosure generates multiple potential outcomes, and considers client and use case priorities to draw conclusive stewardship decisions despite potentially contrary priorities. It captures client intent as part of the experiential data, and uses it overtime to create increasingly sophisticated methods of decisioning, leading to increasingly well-suited and acceptable stewardship decisions with decreasing need for manual intervention. This approach includes the use of experiential data as input to AI methods to generate such continually refined methods and outcomes. The present disclosure is designed to enable maturation of granularity in codifying and prioritizing outcomes for clients, while not forcing all clients to take advantage of such maturation, or even to make changes to avoid regression impacts.

Identity resolution decisioning rules must disambiguate among what may appear to be equally qualified outcomes. It disambiguates among those outcomes by explicitly or implicitly favoring certain indicia over others. For some clients and use cases, the “standard” answer may be fine. For others facing emerging needs for increasingly sophisticated and targeted decision making, multiple combinations of indicia must be attempted, and outcomes and methods used to identify the candidates compared to determine the most optimal one from among the corpus of global entities.

Multiple indicia and sometimes multiple instances of the same indicia need to be considered for similarity to similar yet distinct entities in a premastered universe. Use-caser-specific requirements must be weighed along with the outcome of comparisons of the original indicia versus the attributed entities. Over time, tuning opportunities exist and have leveraged observations about activity, but assumptions must be made regarding the clients' stewardship decision.

The present disclosure includes capture of the client's intent regarding each transaction so it can be leveraged as input to AI methods (i.e., artificial intelligence) and ML (i.e., machine learning) powered ideation for tuning of decisioning rules, and to guide data quality campaigns designed to increase the rate at which clients will deem outcomes to be acceptable. Likely non-dispositive outcomes may be used as valuable insight to the customer and unrequited customer need, as well as used in downstream discovery and curation processes which also support the objectives of increased “accept” stewardship outcomes in the long run.

Humans cannot perform this process. That is, some aspects of the creation of multiple passes might be created manually, but less thoroughly (and certainly subject to human bias) due to the extraction of multiple “views” of the same indicia value to create additional permutations. The recursive analysis across client outcomes would not be possible because of the known fallacies of human construction including confirmation bias, inter-rater bias, fatigue, and other heuristic weaknesses.

The present disclosure also provides many additional advantages, which shall become apparent as described below.

### SUMMARY

A method for semi-automated adjudicated identity resolution comprising: seeking best match entity candidates via a core capabilities stage for the identity resolution for a single pass; and
extending the core capabilities stage with an attribution stage, which assigns a multi-indicia assessment of the retrieved and evaluated candidates, by leveraging the granular indicia assessments; wherein the multi-indicia assessments are grouped by related or similar yet distinct scenarios.

The method wherein the distinct scenarios are at least one selected from the group consisting of: scenarios which include several of the same indicia performing well, but not others; scenarios which based on how well one or more key indicia performed; and combinations thereof.

Another embodiments comprising a method for semi-automated adjudicated identity resolution comprising: seeking best match entity candidates via a core capabilities stage for the identity resolution wherein the core capabilities are is called multiple times in parallel, providing differing subsets of the full inquiry indicia received from client, such that a large number of possible outcomes can be observed depending on which inquiry indica are used in combination with others; and assigning an initial outcome code for the resulting winner for each pass; wherein the initial outcome code may later be promoted or improved when considered in conjunction with the outcome of one or more other pass outcomes.

The method wherein the outcome codes may eventually be reassigned a different outcome code based on reinforcement by information from other pass winners. The reassigned promoted outcome code is one in which clients will typically be more confident than the originally assigned outcome code.

The method further uses use-case and user specific priorities to direct the choice of an ultimate-winning outcome from the winning pass of one of several passes.

The method wherein the use of the outcome codes for each of the singular winning pass outcomes, and precedence specified by clients for preferring specific outcome codes over other outcome codes.

The method wherein the directed stewardship further uses stewardship intent information to assign stewardship decisions to pass outcomes (interim results), one of which will go on to become the winning outcome.

According to still another embodiment, a method that semi-automatically adjudicates identity resolution, the method comprising: receiving inquiry attributes describing a sought after entity;
receiving user preferences and intent related to the sought after entity;
combining the inquiry attributes, the user preferences, and intent;
passing the combined the inquiry attributes, the user preferences, and user intent between 1 to n times, with inquiry data which varies across the multiple passes;
transmitting the generated inquiry data to a searching and matching database which passes in the generated inquiry data recursively or in parallel until need and opportunity have been exhausted;
determining an initial simplified codification of an outcome from each pass;
identifying of reinforcement outcomes from each pass and recodifying the reinforced outcomes;
assigning intent based on ultimate code per instance; capturing a copy of each experience, i.e., the details of each pass;
determining whether sufficient passes have been executed to yield an acceptable result and, if not, then recursively generating and executing additional possible passes informed by the earlier ones;
anchoring unspecified codes to specified codes;
reviewing the passes and generating rank outcomes based on ultimate codes and custom-specified precedence; and
returning a winning outcome and intent.

Further objects, features and advantages of the present disclosure will be understood by reference to the following drawings and detailed description.

### BRIEF DESCRIPTION OF THE DRAWINGS

FIG. 1 is a chart according to the present disclosure depicting multi-disciplinary stewardship with client-controlled customization together with reliable core functionality.

FIG. 1A is a flowchart depicting client and client support interaction with capability according to the present disclosure.

FIG. 2 is an end to end flow chart according to the present disclosure.

FIG. 3 is a chart according to the present disclosure depicting overall interactions which enable multiple potential outcomes to be compared in view of client/use case priorities, client intent application, reinforced outcomes, directed stewardship, and continuous maturation of the system.

FIG. 3a is a chart according to the present disclosure with an example of step 1a) from FIG. 3 with multiple versions of each indicia.

FIG. 4 is a chart according to the present disclosure with an example of step 1b) from FIG. 3 with acceptance of preference/precedence information with example outcomes, and client intent for this outcome (i.e., stewardship decision).

FIG. 5 is a chart according to the present disclosure with an example of steps 2 and 3 from FIG. 3 which interpret certain provided indicia to extract and create multiple additional view/sub-views of these inquiry indicia, and then create permutations of all such inquiry indicia.

FIG. 6 is a chart according to the present disclosure with an example of step 4 from FIG. 3 demonstrating repeated requests from data characteristics and which leverages identity resolution to process each permutation as a “pass”.

FIG. 6a is a chart according to the present disclosure with an example of step 4 from FIG. 3 which leverages identity resolution to process each permutation with input from global corpus of entities and experiential data in response to customer requests and issues a response. FIG. 7 is a chart according to the present disclosure with an example of step 5 from FIG. 3 which initially codifies the outcome of each pass based on the indicia used, the assessment of similarity between inquiry and identified entity, and other observations about the matched data points.

FIG. 7.1 is a chart according to another version of the present disclosure shown in FIG. 7 with additional attribute(s) included or available for each of the identified records, wherein one attribute is an optional reference to a Related Record ID.

FIG. 7A is a block diagram of the application architecture according to the present disclosure.

FIG. 8 is a chart according to the present disclosure with an example of step 6 from FIG. 3 which identifies opportunity to promote some outcome codifications based on outcome of other passes.

FIG. 8.1 is a chart according to another version of the present disclosure shown in FIG. 8 with a common Related Record ID which indicates the two different records (Record IDs) returned by passes 1 and 10 that are sufficiently related to support a Reinforcement conclusion. Similarly, a Related Record ID which is the same as a Record ID returned by a different pass may qualify as reinforcement. Variations of reinforcement may be used to justify differing promotions.

FIG. 8A is a chart according to the present disclosure with an example of step 7a) from FIG. 3 which considers the received precedence information and the codified outcome of each permutation/pass, and chooses the best one for the client. The client-specified precedence information is used to rank the pass results shown in FIG. 8 and choose the best one for this client.

FIG. 9 is a chart according to the present disclosure with an example of step 7b) from FIG. 3 which performs this ranking of outcomes with the ability to presume the client intent in scenarios where specific codes have not been specified by the client, thus enabling the capability to evolve, and assign newly defined codes, without requiring all clients to specifically embrace every possible code/outcome.

FIG. 10 is a chart according to the present disclosure with an example of step 7b) from FIG. 3 similar to FIG. 9 above with different winning pass.

FIG. 11 is a chart according to the present disclosure with an example of step 7b) from FIG. 3 similar to FIG. 9 above with different winning pass.

FIG. 12 is a chart according to the present disclosure with an example of step 8) from FIG. 3 which adds the stewardship decision specified by the customer for each pass, based on its outcome code.

FIG. 13 is a chart according to the present disclosure with an example of step 9) from FIG. 3 which captures the outcome of all requests, the ultimate decision/result, and the customer intent as experiential data.

FIG. 14 is a logic flow diagram according to the present disclosure with an example of step 10) from FIG. 3 which leverages stewardship intent when considering tuning enhancements and use as training data to inform additional candidate retrieval and decisioning methods in a manner to enable an ever-improving process.

FIG. 15 is a computer block diagram used by the present disclosure.

### DETAILED DESCRIPTION OF THE PREFERRED EMBODIMENT

The present disclosure includes core capabilities which must remain repeatable and reliable, yet the overall capability must accept client priorities and intent relative to specific outcomes from the core system. These objectives are accomplished via an orchestration of attempts using multiple combinations of inquiry indicia, coding of outcomes, client precedence consideration, intent mapping and capture, and extensibility of codification approach to enable maturation with more granular sub-coded outcomes without requiring all clients to embrace those maturations. Logged metadata is leverage by AI modeling to identify data gaps having the most significant negative impact on willingness of clients to auto-accept the resulting answer, and to identify improved adjudication rules for the core process or client recommendation.

With the present disclosure, clients will be able to customize their experience based on the priorities of their use case. Consideration of the specified priorities, rather than a default prioritization, will yield increasingly acceptable results. Capture of the customer intent for each transaction will help generate aggregative learnings for process maturation. The process of seeking the “best” matching candidate from the global corpus already must be extremely fast. The present invention is about making the choice of returned entity better and more likely to be accepted by introducing more information about the client priorities without extending the time to find it, and about leveraging knowledge of their intent to improved quality of future performance.

The present disclosure requires computer implementation to enable sufficiently fast execution to be included in time critical applications, and to support the intersection of client priorities with the dynamic outcomes of multiple parallel passes through the core identity resolution capability.

The present disclosure further introduces unpredictable human behavior to enable the machine to realize the full embodiment of conventional technology and identifies the outcome which best fits the client's intended use or use case. Additionally, by capturing the client's intended decision to accept, reject, or review the ultimate result, their experience can be used as input to a learning model to identify gaps in the corpus of data on which to focus improvement efforts, and to tune decisioning methods.

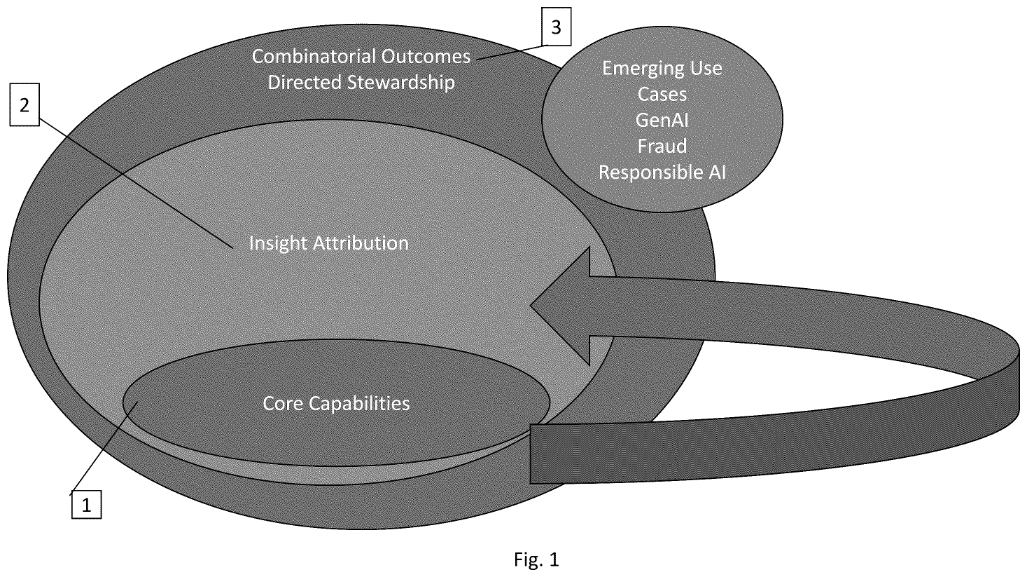

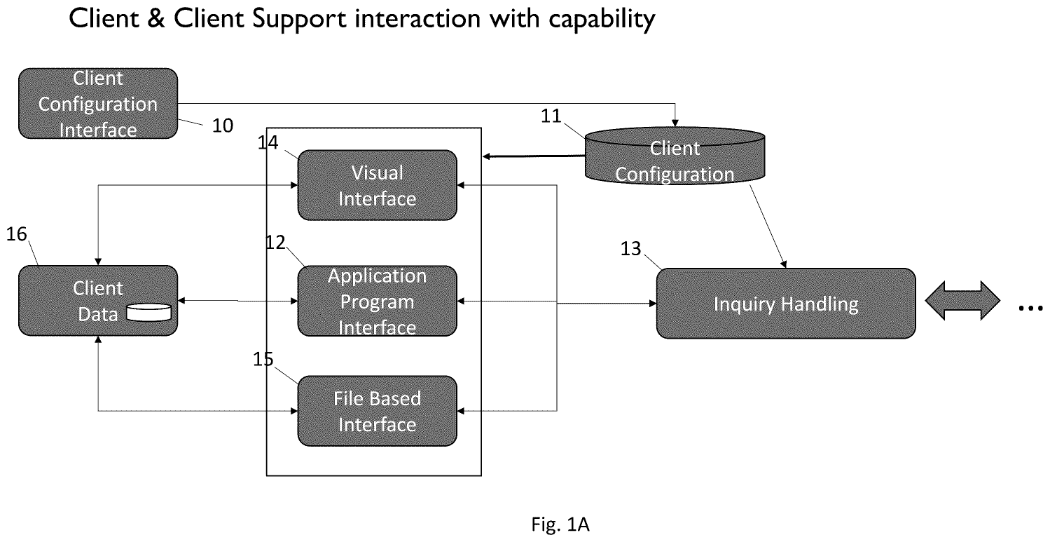

The present disclosure can best be described by referring to the figures. FIG. 1 is a chart according to the present disclosure depicting multi-disciplinary stewardship with client-controlled customization together with reliable core functionality. That is the present disclosure builds on existing portfolio of global identity resolution capabilities. Emerging needs for sophisticated multi-disciplinary stewardship necessitates client-controlled customization while retaining reliable core functionality. FIG. 1 further depicts conventional matching capabilities (2) supplemented by a summarization code which describes the outcome regarding the multiple types of traditional/prior insight. It also depicts the additional level of intelligence (3) and insight resulting from either combining information about multiple outcomes (reinforcement by a different pass outcome) or additional assessment within a single pass outcome (reinforcement of, e.g., an Independent ID-based result where there is also similarity of the returned name versus the inquiry name), plus directed stewardship as specified by the client either in advance or at the time of the request submission.

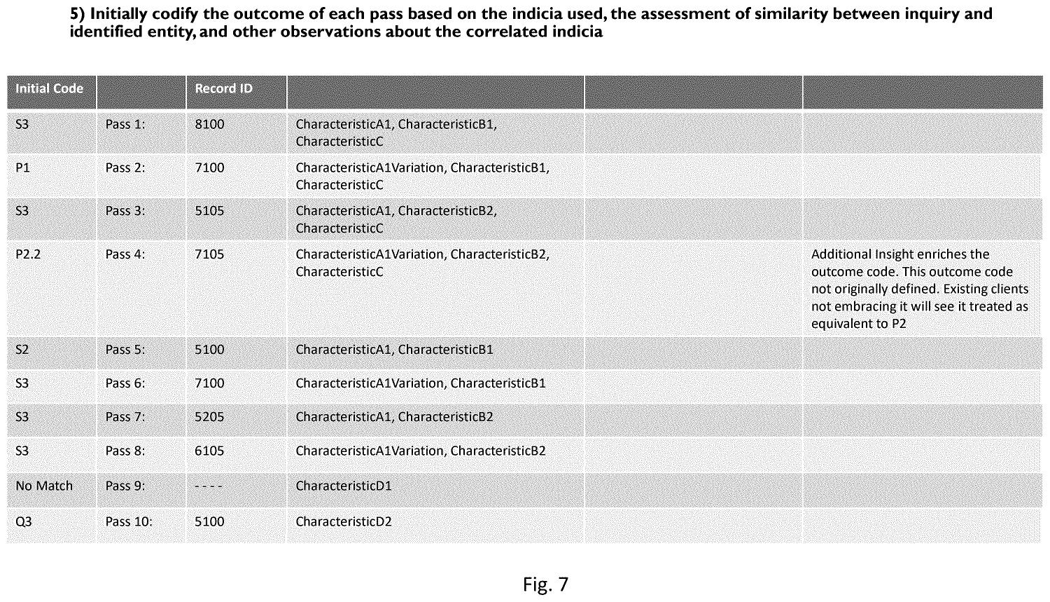

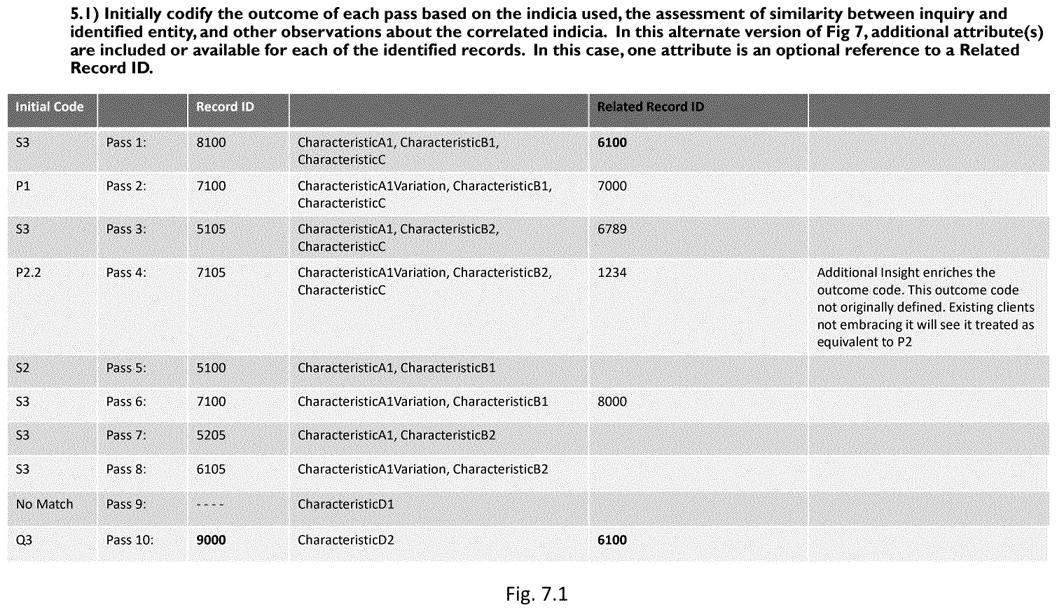

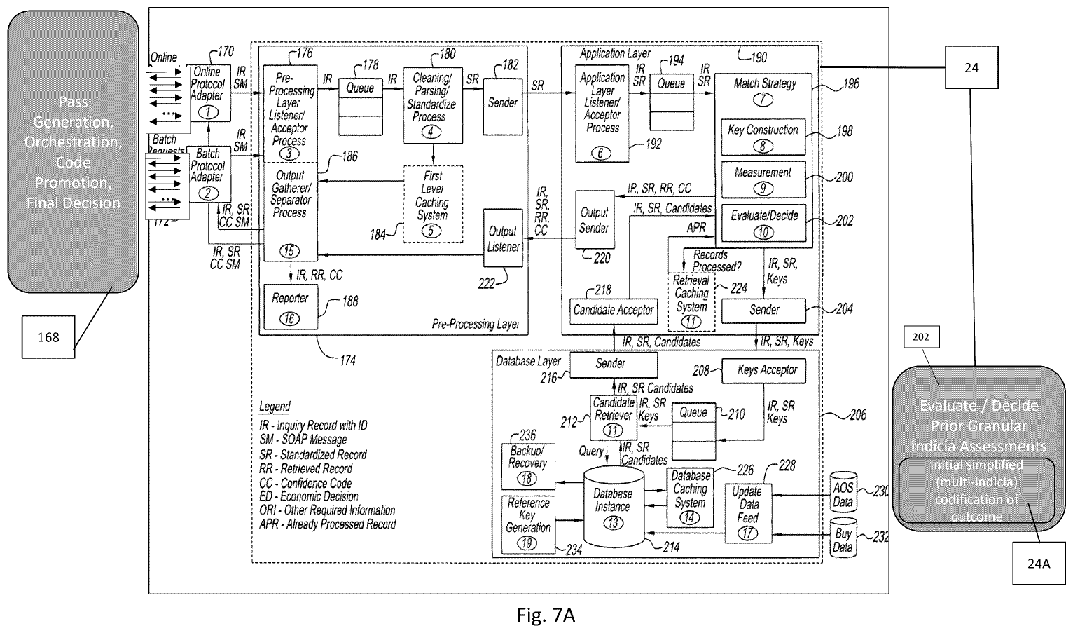

The core capabilities stage of identity resolution 1 involves the following steps: (1) cleanse, parse, and standardize (CPS) data, (2) retrieve candidates from such CPS data, and (3) evaluate granular indicia and decide on the best match as per standard prioritization. The core capabilities stage 1 (i.e., CPS, candidate retrieval, and evaluation and decisioning) is paired with insight attribution stage 2 supplemented by a summarization code which describes the outcome regarding the multiple types of traditional or prior insight (i.e., insight, including customer intent, to mature data collection strategy and adjudication process). Insight attribution stage 2 provides an assessment of the returned candidate and other candidates regarding multiple granular indicia, i.e., what specific attributes were compared. Insight attribution includes: overall assessment—how the host feels; per indicia assessment—more granular; profile information—what was compared; flexible alternative indicia; and summarized assessment. Using flexible alternative indicia, the core capability stage 1 can extend the set of indicia for which granular assessments are provided. These multiple granular assessments are used to assign an overall assessment of how the capability host “feels” about the retrieved candidates and decisioning from stage 1. With the current disclosure, “per indicia assessment” or flexible alternative indicia, and other information from insight attribution stage 2 are summarized in a more specific way than the overall “How we feel” assessment. This additional or new assessment is codified and initially assigned without regard for other possible passes which may exist and support the original inquiry. The initial assessment and outcome code assignment is done during stage 2 insight attribution, and is an expansion of that functionality shown in FIG. 7A, step 24A.

In stage 3 (i.e., combinatorial outcomes and directed stewardship), the current disclosure further assesses the outcomes of multiple passes supporting a single original inquiry, reviewing and comparing the outcomes to each other to identify the potential to promote some based on reinforcement by the outcome of others, and to choose which conventional granular insight to return along with the newer summary insight/outcome code. Stage 3 also considers use-case and client provided specific priorities to direct the choice from among multiple passes and outcomes. It then also accomplishes directed stewardship by leveraging client-provided stewardship intent information to assign a stewardship outcome. By assigning stewardship outcomes for all passes, more extensive experience is gained regarding even the outcomes which are ultimately not returned to the client. Consideration of the customer specified priorities/precedence of codified summarized outcomes to select the best result leads to the final decision/choice of candidate, enabling the client to customize their experience and leading to a much more satisfying experience for the client. The use of their additional direction on stewardship intent not only makes it convenient for the client to action results, but also enables the capability to more effectively evolve through tuning feedback. Reinforced results, customized priorities, and maturing assessments lead to results which are easier to initially configure and leverage, and return results fit for purpose regardless of variation across client/use case needs.

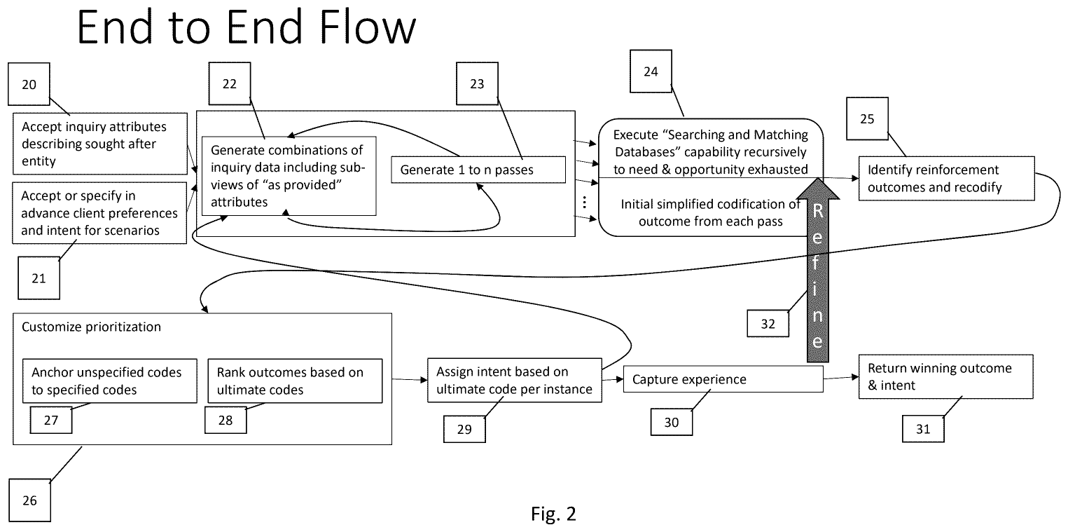

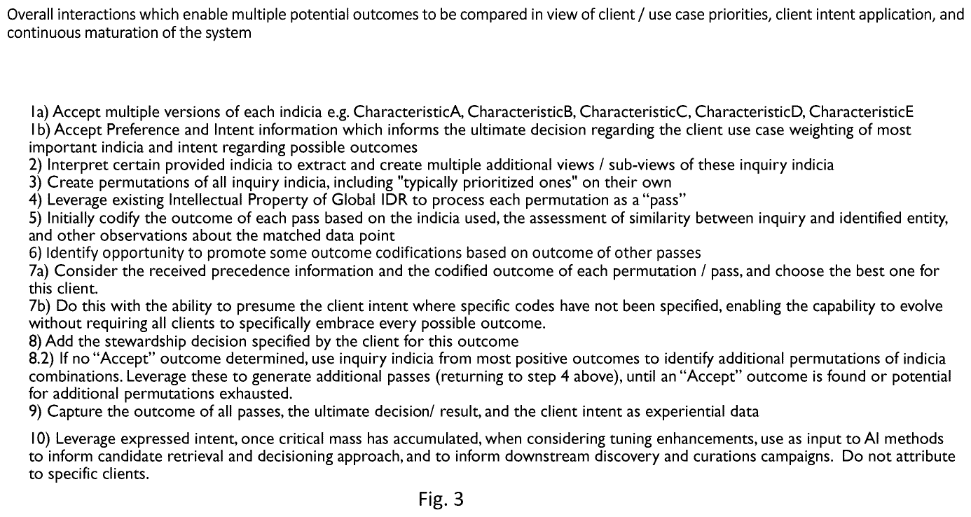

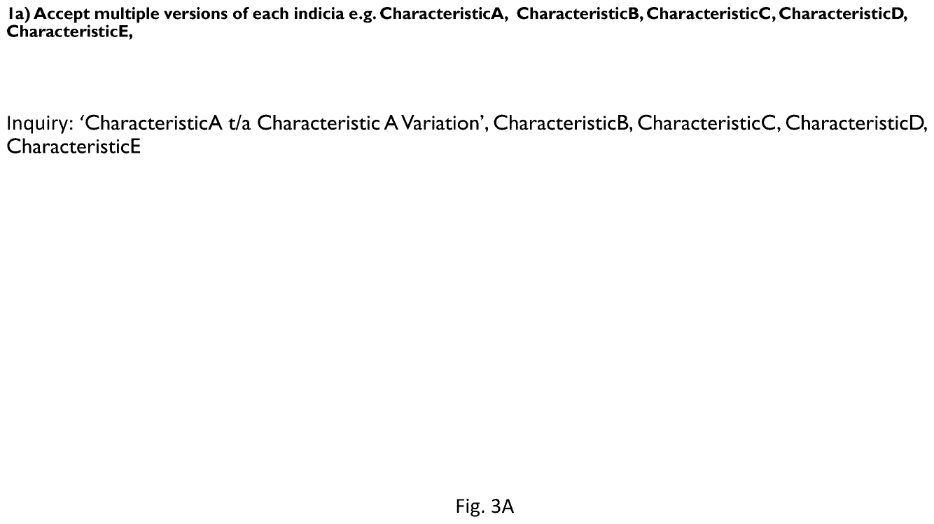

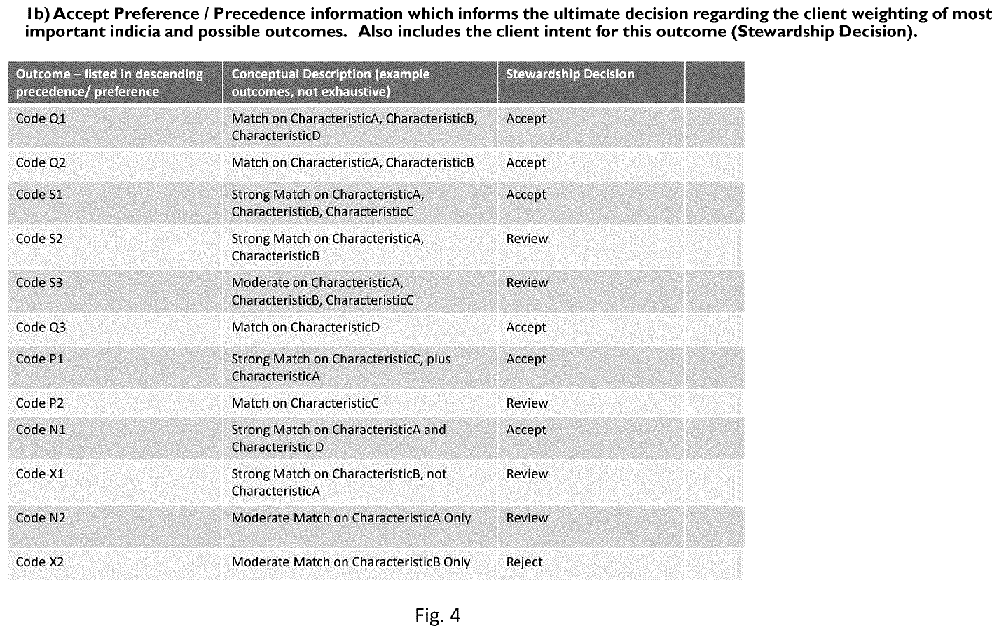

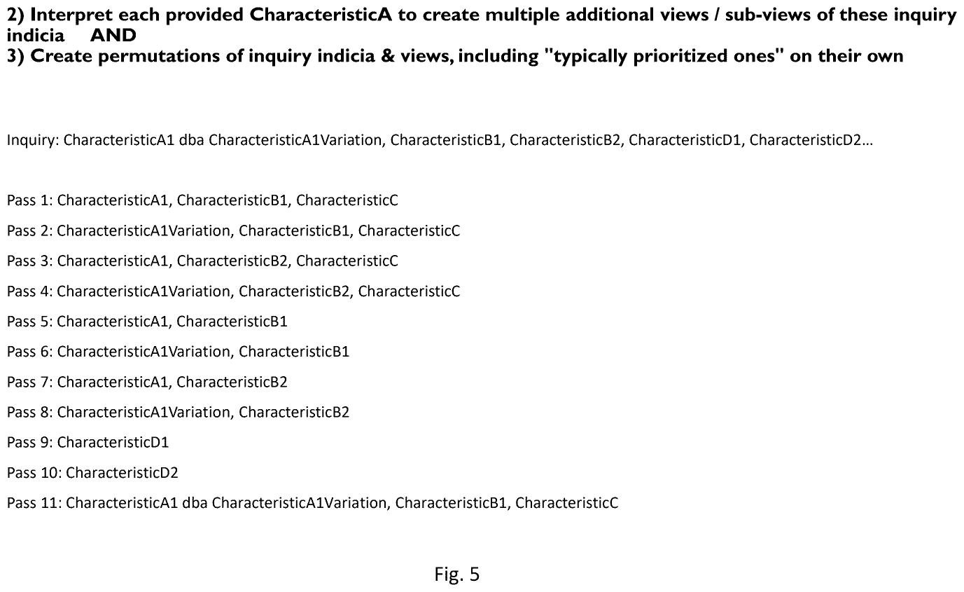

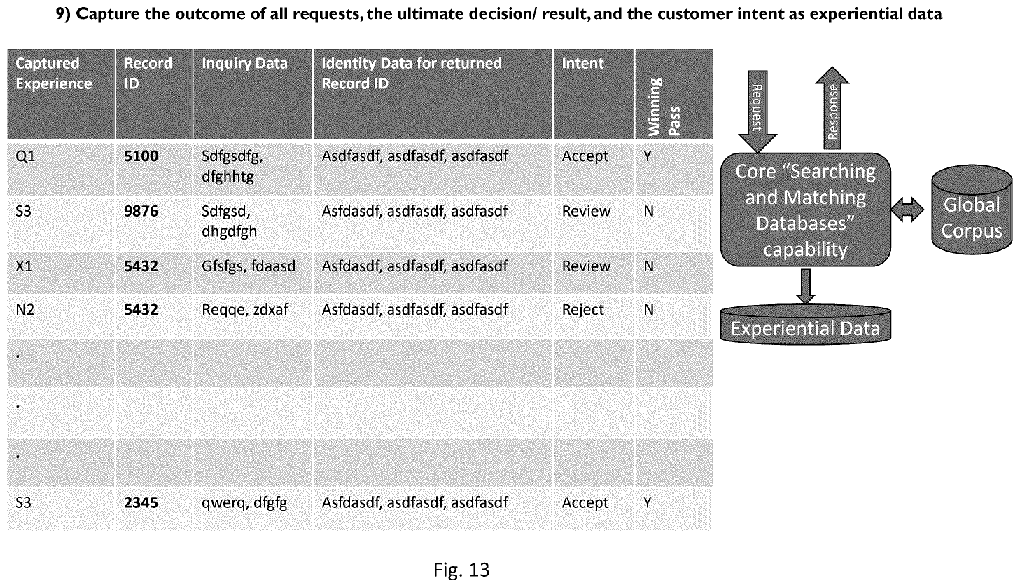

FIG. 1A is a flowchart depicting client and client support interaction with capability according to the present disclosure. The inclusion of client configuration highlights the need and opportunity for the client to specify their priorities regarding potential outcomes, and their intent regarding those various possible outcomes. With conventional technologies, they are subject to standard or assumed priorities among the use of various indicia and outcomes. FIG. 1A depicts the various relationship between the various figures in the present disclosure, wherein client configuration interface 10 (FIG. 1) controls client configuration 11 (FIG. 1A) that then sends it configuration to visual interface 14 (FIG. 3A), application program interface 12 (FIG. 4), and file based interface 15 (FIG. 5) via inquiry handling 13 (FIG. 13). Interfaces 12, 14, and 15 each communicates with client data 16 (FIG. 2).

Using FIG. 1A as a guide, an example set of client interactions and supporting activities follows:

1. Client uses Client Configuration Interface 10 to set up a profile which will be retained and associated with them going forward.

Client specifies they will provide inquiry data potentially including data fields for Name1, Name2, Address1, Address 2, Phone(s), and Independent Identifier(s).

Request: Gorman Bros DBA Gorman Manufacturing, Bill Gorman Enterprises, 25 Commerce Boulevard, Allentown, PA, 10111, 321 River Street, Bethlehem, PA, 10122, 484-021-0001, 123456789.

They will either choose from one of a set of “standard” profiles or create their own profile.

The profile will specify, e.g.,
a. Precedence in order of preferred outcomes. In this example, they specify a strong preference for an outcome where the returned record is found and supported by the same or similar data to the inquiry with regard to Independent Identifier and Name & Address data. The profile they create or choose lists possible outcome codes ranging from one which indicates a match based on all of Independent ID, Name, and Address, to a different possible outcome code which indicates a match based solely on Address data. This precedence aspect of the configured profile is similar to what is depicted in FIG. 4.
b. Intent (i.e., stewardship decision) regarding the known possible outcome codes. For example, if the final result is returned as a Code Q1, they intend to automatically accept it. Alternatively, if the outcome code of the final result is returned as Code X2, they intend to automatically reject it. They specify their intent for each known outcome code as a stewardship decision, as shown in FIG. 4.

2. Client configuration (11) is stored by a participating party, such as the hosting service, or by the client itself.

3. The Client prepares a request for service on a single organization of interest to them, providing a Name(s), Address(s), Phone(s), and Independent ID(s).

4. Client provides this information as an inquiry/request to an interface 12, 14, or 15 and explicitly or implicitly includes with the request either the detailed client configuration 11 information or information such as a profile ID which references it in the service environment.

5. The interface 12, 14, or 15 calls on the appropriate next level of access which handles such inquiries. Logically, this activity is represented by 20 of FIG. 2 accepting the request attributes as shown above, and accepting or specifying, in advance, client preferences and intent for various scenarios 21 of FIG. 2, i.e., accepting the client configuration, e.g., accepting preference and/or precedence information which informs of the ultimate decision regarding the client weighting of most important indicia and possible outcomes as shown in FIG. 4.

6. Processing proceeds as described by FIG. 2. Example of this detail documented below.

7. The best possible result for this client, after attempting multiple combinations and permutations of data as inquiry elements submitted passes to the enhanced existing environment, and consulting the client-specified precedence information to choose the one “winning pass” is returned to the client through the original interface layer, e.g., 12, 14, or 15. Included is the applicable stewardship outcome or intent, based on the client-specified intent for that outcome code.
Request: Gorman Bros DBA Gorman Manufacturing, Bill Gorman Enterprises, 25 Commerce Boulevard, Allentown, PA, 10111, 321 River Street, Bethlehem, PA, 10122, 484-021-0001, 123456789. Response: Summary Code=Q1, “Matched on Name 1, Address 1, and Independent ID1. Entity: Gorman Manufacturing, 25 Commerce Blvd, Upper Saucon, PA, 10111, 484-765-4321, 123456789.

8. While not specifically shown on the diagram, once the client receives the result along with the intent/stewardship decision, if it is to be “Accepted” they then accept and save the record identifier for the data into their own environment. Thereafter, the client will take various use-case specific actions such as purchasing more information about the returned entity, and evaluates that information and makes a business decision such as to (1) extend credit for a product sale, (2) approve purchase from a supplier, or (3) integrate new data to a global corpus of data being prepared to support a variety of use cases.

If rather than a stewardship decision of “Accept,” the client receives back “Review,” then the result would be reviewed by the client who will make a final decision and either Accept or Reject the result. If accepted, then see example actions above.

If rejected, then the client will likely reject the result as insufficiently satisfying for their requirements/use case.

FIG. 2 is an end-to-end flowchart according to the present disclosure, wherein the system accepts inquiry attributes describing sought after entity 20, and accepts or specifies, in advance, client preferences and intent for specific scenarios 21. Thereafter, the system generates combinations of inquiry data 22, including sub-views of “as provided” attributes. This combination of inquiry data is used 23 with varying methods to generate 1 or more passes.

The system then sends the combination of inquiry data 22 to the searching and matching databases 24 which have the capability of recursively checking until need and opportunity have been exhausted. As well as determining the initial simplified codification of outcome from each pass 23. Thereafter, the system identifies reinforcement outcomes and recodifies 25. Reinforcement is detected when more than one independently processed pass through core capabilities stage 1 yields the same entity/record ID. These outcomes corroborate one another, and when the supporting indicia used in each are truly independent of each other, such as externally assigned ID versus naturally occurring characteristics, that corroboration indicates a “reinforced” outcome. While the primary method of reinforcement is two independent passes corroborating one another, it can also occur when one pass has returned an entity based on indicia, and a subsequent review of other indicia finds that additional characteristics from the inquiry which were not used to support the original pass also compare successfully to the record being returned. For example, if the pass identified the record being returned based solely on a unitary characteristic, but an independent characteristic is also found to be dispositive with respect to the record being returned, this outcome reinforces the initial finding. This outcome helps reassure the client the original characteristic was likely accurate and increases the client's likelihood of accepting the result.

The system then generates customized prioritization 26 of the recodified outcome 25 by anchoring unspecified codes to specified codes 27 and ranking outcomes based on ultimate codes 28. This recoding/outcome code refinement and ranking activity is followed by assigning intent based on the ultimate code per instance 29 and then experiential data is captured 30. The revised ultimate code with intent and experience generate a winning outcome and intent, or is recursively sent back 32 to searching and matching step 24 with revised inquiry indicia to pursue a dispositive outcome.

An example of the processing described by FIG. 2 includes the following:
1. FIG. 2, item 20 accepts the request attributes, e.g.,
   Name 1: Gorman Bros DBA Gorman Manufacturing
   Name 2: Bill Gorman Enterprises
   Address 1: 25 Commerce Boulevard, Allentown, PA, 10111
   Address 2: 321 River Street, Bethlehem, PA, 10122
   Phone: 484-021-0001
   Independent ID 1:123456789
   Independent ID 2:987654321
2. FIG. 2, item 21 accepts the client configuration as shown in FIG. 4.
3. FIG. 2, items 22 and 23 generate combinations of inquiry data including subviews. Not all possible views and combinations are shown. Natural Language Processing is used to extract multiple views of names. Multiple permutations are generated for each:
   Pass 1:
      Gorman Bros DBA Gorman Manufacturing 25 Commerce Boulevard, Allentown, PA, 10111 Phone: 484-021-0001
   Pass 2:
      Gorman Bros 25 Commerce Boulevard, Allentown, PA, 10111 Phone: 484-021-0001
   Pass 3:
      Gorman Bros DBA Gorman Manufacturing 321 River Street, Bethlehem, PA, 10122 Phone: 484-021-0001
   Pass 4:
      Gorman Bros 321 River Street, Bethlehem, PA, 10122 Phone: 484-021-0001
   Pass 5:
      Gorman Bros DBA Gorman Manufacturing 25 Commerce Boulevard, Allentown, PA, 10111
   Pass 6:
      Gorman Bros 25 Commerce Boulevard, Allentown, PA, 10111
   Pass 7:
      Gorman Bros DBA Gorman Manufacturing 321 River Street, Bethlehem, PA, 10122
   Pass 8:
      Gorman Bros 321 River Street, Bethlehem, PA, 10122
Pass n:
   123456789

The inquiry indicia values for each pass are sent in parallel to the enhanced searching and matching database.

That is, FIG. 2, item 24, shows each pass of inquiry data sent to the searching and matching databases system and method. The system and method is enhanced FIG. 7A 24 such that each outcome has additional insight created and added to the result. Following initial and/or preexisting evaluation and decisioning processing to create both internal or intermediate and external/final match insight and choose the best resulting candidate for the indicia on this particular pass, the enhanced approach considers that match insight across indicia, seeking combinations of granular indicia results to recognize scenarios which enable assignment of a summary or outcome code meaningful to clients having specific use cases and/or desiring a more holistic overview of the result. This single summary code value classifies the outcome into a grouping of similar possible outcomes, and describes levels and type of confidence within grouping. For example, it might classify and codify an outcome as having matched “exactly” on Name, plus elements of Address, and Phone matched. The code for a different pass might classify it as having succeeded based on an Independent ID lookup (FIG. 7 pass 10). Yet a third pass might be codified to show it matched well on Name and Phone Number. A fourth pass might be codified to show it matched well only on the Name and Address indicia (FIG. 7 passes 6, 7, and 8). Examples of potential outcomes and summary codes for multiple passes of the same inquiry are shown in FIG. 7. The outcome code on FIG. 7 pass 4 will be used to demonstrate a different feature in a separate section of the present disclosure.

Continuing through FIG. 2, step 25, examines the outcome of each pass, and the summary code initially assigned to it. It looks across all the outcomes and detects scenarios such as multiple passes and codes indicating the same entity/Record ID was found based on significantly different indicia. An example is FIG. 7 where an outcome codified/described as S2 from Pass 5 for Record 5100 is present, and a different outcome codified/described as Q3 from Pass 10. These two outcomes identifying the same entity/record 5100 based on both Name and Address, and separately based on Independent ID will enable the code assigned to pass 5 and/or pass 10 to be upgraded to a “Q1”, indicating success based on both Name & Address AND based on Independent ID. The term “reinforcement” is used to describe the fact that two independent sets of indicia found or at least are consistent for the same entity.

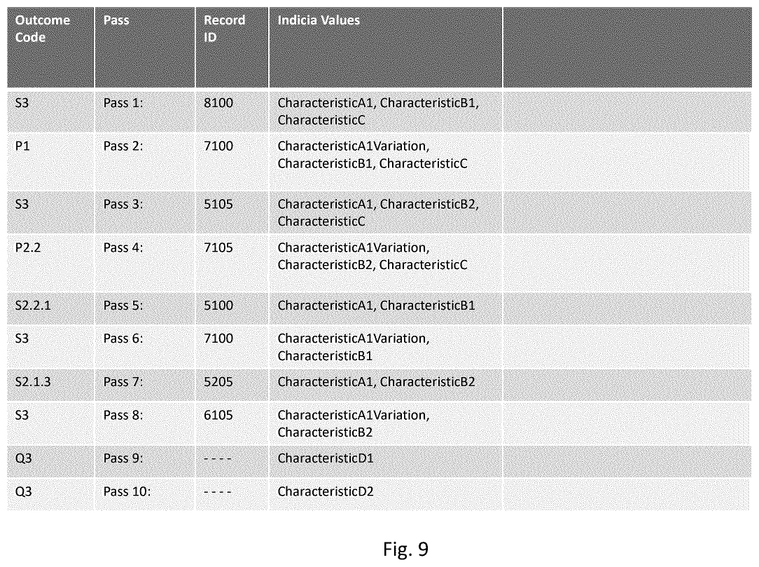

Continuing through FIG. 2, step 27, identifies assigned outcome codes which were not specifically listed in the precedence profile/prioritization specified in client configuration for this inquiry. When this occurs, a method of inference shown in FIGS. 9, 10, and 11 is used to determine an appropriate code which was specified in the client configuration, and that code will be used to anchor/indicate the precedence position for the code which was not specified in the client configuration but was returned on one or more passes. This approach enables maturation of the system without waiting for every client to embrace each potential new outcome summary code before such new summary code can be returned to all/any clients.

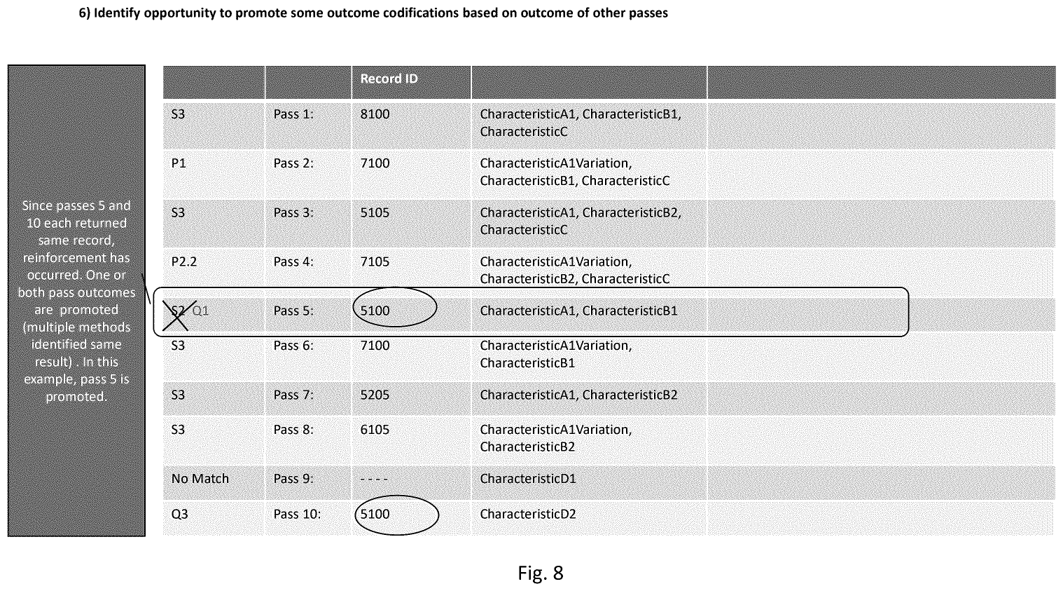

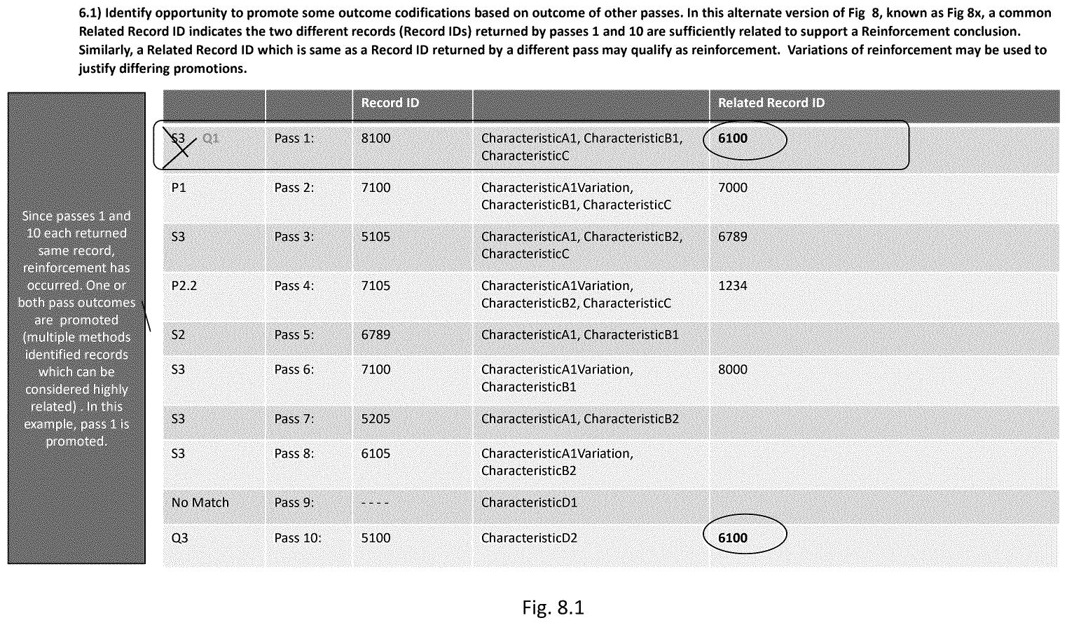

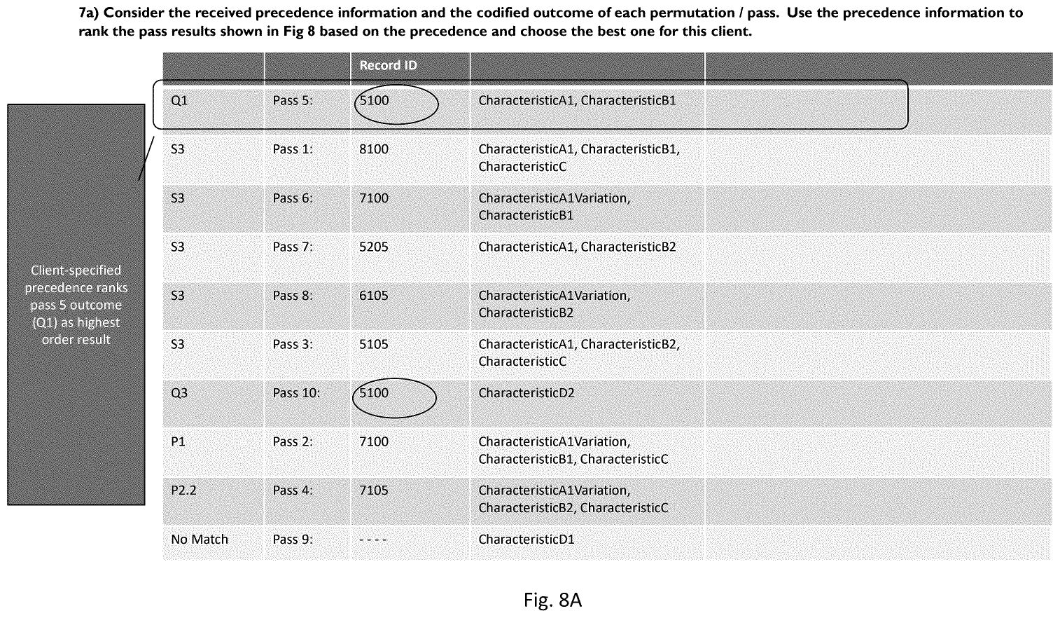

The outcome summary code from each pass, or one to which it is anchored, is referenced in the precedence part of the client configuration. In FIG. 2, step 28, the ranking of possible codes is used as a reference to order the actual codes assigned to each pass, and to order the pass results along with them. This activity is demonstrated in FIG. 8A. This technique is used to rank the pass outcomes as per the client's priorities, as expressed in the client configuration.

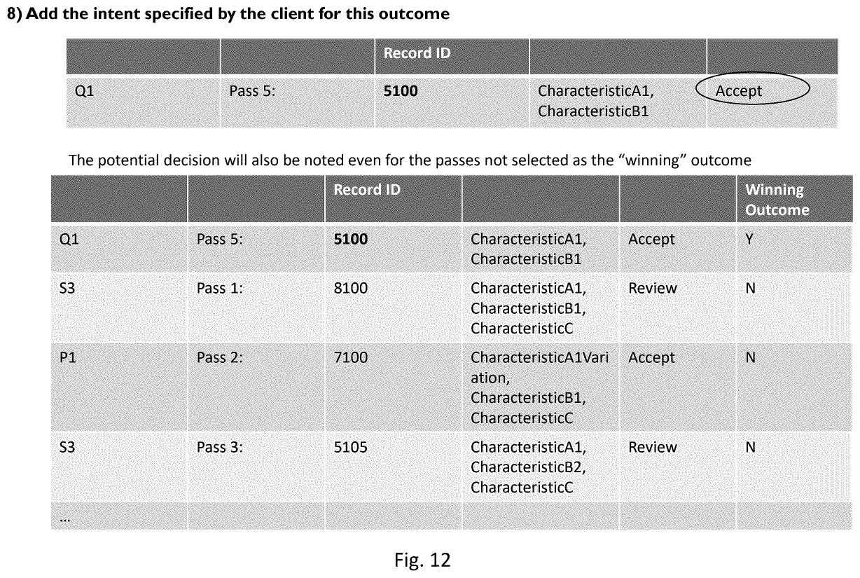

FIG. 2, step 29, and FIG. 12 leverage the outcome code for each pass and reference the corresponding code or anchor code in the client configuration to obtain the intended stewardship decision associated with the outcome code, and assign the stewardship decision to the pass. Assignment of the stewardship decision/intent is done even for passes which are not the “winning pass.”

FIG. 2, step 30, and FIG. 13 captures experience throughout the method including both winning and non-winning passes. This information is accumulated over the course of time for the multitude of requests serviced. The winning pass results are communicated to the client as a response FIG. 2, step 31.

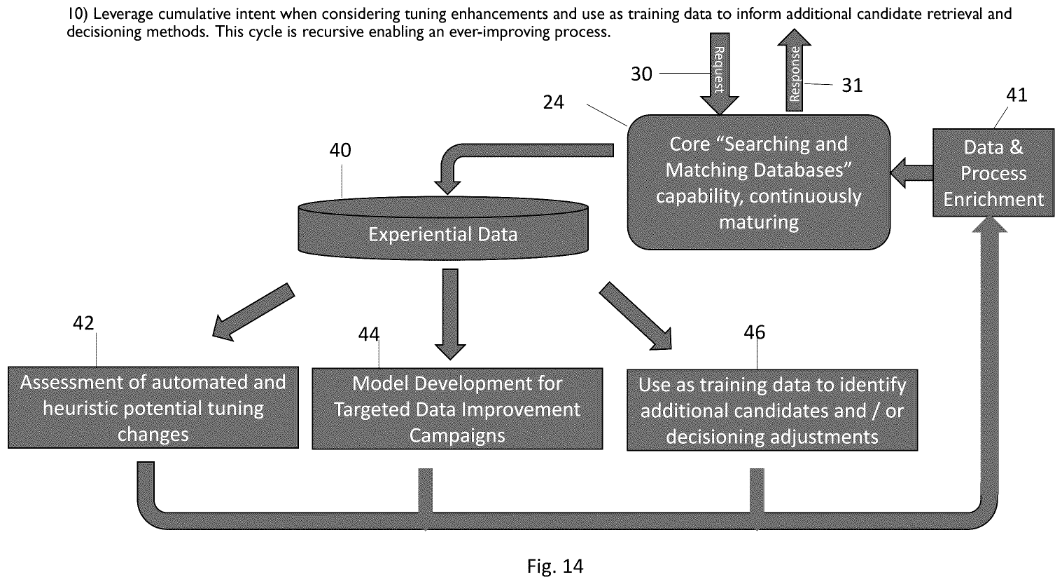

FIG. 2, step 32, and FIG. 14 leverage accumulated metadata from FIG. 2, step 30 and FIG. 14, datastore 40, and FIG. 13 as input to FIG. 14, steps 42 and 46 heuristic and artificial intelligence methods to identify and generate opportunities to create new methods of candidate retrieval and tuning of evaluation and decisioning techniques which can mature the original searching and matching databases FIG. 14, step 24, capability. An example of maturation may be, e.g., recognition that certain patterns present in the inquiry and reference data imply a relationship which can be exploited as a new key used to support future inquiries, or to add attribution which when present have been determined to be a frequent contributing factor to yield outcome codes which clients “Accept.” Additionally, experiential data 40 is used as input FIG. 14, step 44, to analyze and identify areas of highest opportunity to create a continually improving experience for clients by generating data improvement campaigns to grow the global corpus of data which is the target of searching and matching of databases 24.

An example of improving results may be to recognize segments among the global corpus of data experiencing lower than average rates of “Accept” outcomes, including characteristics of the unrequited inquiry data which will help identify specific strata of within the segment upon which to focus.

The experiential data is used to continuously improve results, and the improved system continues to capture experiential data which results from the improved system. The more advanced experiential data is used in a comparable manner to create even more improvement.

FIG. 3 is a chart according to the present disclosure depicting overall interactions which enable multiple potential outcomes to be compared in view of client/use case priorities, client intent application, and continuous maturation of the system. The steps include, but are not limited to, the following:
1(a). Accept multiple version of each indicia, e.g., Characteristic A, Characteristic B, Characteristic C, Characteristic D, and Characteristic E.
1(b). Accept preference and intent information which informs the ultimate decision regarding the client or customer's use case weighing the most important indicia and intent regarding possible outcomes.
2. Interpret certain provided indicia to extract and create multiple additional views/subviews of these inquiry indicia.
3. Create permutations of all inquiry indicia, including typically prioritized ones on their own.
4. Leverage identity resolution system to process each permutation as “pass.”
5. Initially codify the outcome of each pass based on the indicia used, the assessment of similarity between inquiry and identified entity, and other observations about the matched data point.
6. Identify opportunity to promote some outcome codifications based on outcome of other passes or based on other indicia in the same pass. Recognition of reinforcement and re-codification captures information about multiple outcomes reached by independent passes, or about corroborating information from the original inquiry compared to the returned record and assigns a more confidence-inspiring outcome code to the result which will reach the customer.
7(a). Consider the received precedence information and the codified outcome of each permutation/pass, and choose the best one for this client.
7(b). Do this ranking and choice of the best outcome for the client with the ability to presume the client or customer's intent where specific codes have not been specified among their precedence information, enabling the capability to evolve without requiring all clients to specifically embrace every possible outcome.
8. Add the stewardship decision specified by the customer for this outcome.
9. Capture the outcome of all passes, the ultimate decision/result, the customer intent as experiential data.
10. Leverage stewardship intent once critical mass has accumulated, when considering tuning enhancements and use as training data to inform additional candidate retrieval and decisioning methods. Do not attribute to specific customers, other than potentially by category/industry.

FIG. 3a is a chart according to the present disclosure with an example of step 1a) from FIG. 3 with multiple versions of each indicia.

FIG. 4 is a chart according to the present disclosure with an example of step 1b) from FIG. 3 with acceptance of preference/precedence information with example outcomes, and client intent for this outcome (i.e., stewardship decision).

FIG. 5 is a chart according to the present disclosure with an example of steps 2and 3 from FIG. 3 which interpret certain provided indicia to extract and create multiple additional view/sub-views of these inquiry indicia, and then create permutations of all such inquiry indicia.

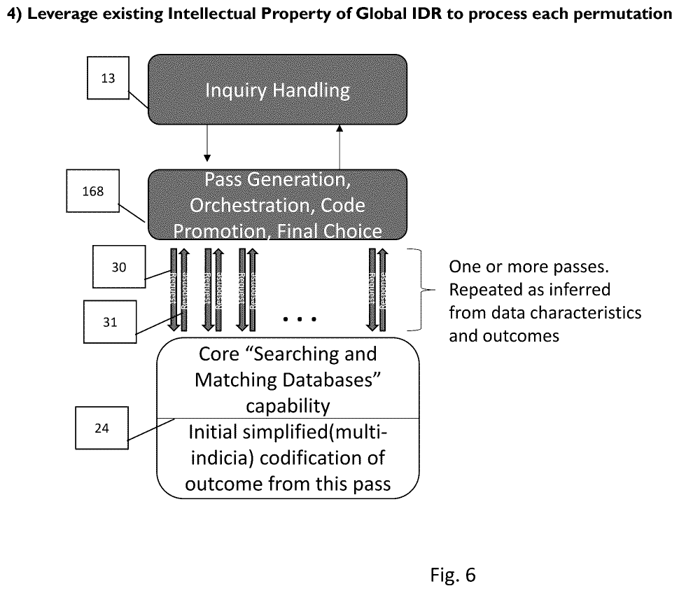

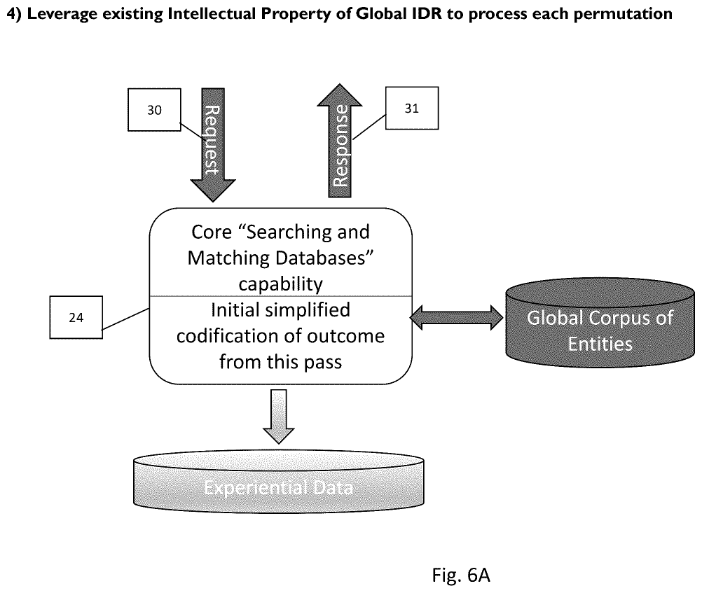

FIG. 6 is a diagram according to the present disclosure with an example of step 4 from FIG. 3 demonstrating repeated requests from data characteristics and which leverages identity resolution to process each permutation as a “pass.” FIG. 6 includes inquiry handling 13 which communicates with pass generation, orchestration, code promotion, and final choice 168. Pass generation 168 performs one or more passes via request 30 and response 31 with core “searching and matching databases” capability and initial simplified codification of outcome from pass 24, which is repeated as inferred from data characteristics. The inquiry data itself drives the generation of multiple passes and there is no limit on the number of passes generated.

FIG. 6a is a chart according to the present disclosure with an example of step 4 from FIG. 3 which leverages identity resolution to process each permutation with input from global corpus of entities and experiential data in response to customer requests 30 and issues a response 31 via core “searching and matching database” capability and initial simplified codification of outcome from this pass 24. See also FIG. 14.

FIG. 7 is a chart according to the present disclosure with an example of step 5 from FIG. 3 which initially codifies the outcome of each pass based on the indicia used, the assessment of similarity between inquiry and identified entity, and other observations about the matched data points.

FIG. 7.1 is a chart according to another version of the present disclosure shown in FIG. 7 with additional attribute(s) included or available for each of the identified records, wherein one attribute is an optional reference to a Related Record ID.

FIG. 7A provides a block diagram of the application architecture according to the conventional single pass of the many included in the present disclosure, with the addition of initial codified summarization of outcome which is also specific to the present disclosure. The use of extensive memory and asynchronous message queues enables the system to achieve high throughput, i.e., use of a standard web-service interface allows for easy interoperability with other systems. In its simplest detail, the application architecture of FIG. 6 includes a pass generation orchestration, code promotion, and final decision engine 168.

The present disclosure modifies the process of U.S. Pat. No. 7,392,240 by assigning initial codified additional summarization of insight 24 to the result. The summarization is effected by examining the granular assessments of indicia 24 to detect successful comparison/match of specific combinations of indicia, such as Characteristic A and Characteristic B are both strongly successful, or Characteristic A and Characteristic D are strongly successful. Various combinations support specific summarization codes and the combinations and their corresponding summarization codes are grouped according to themes which are meaningful to clients of the capability.

An outcome from a pass showing a favorable comparison for Characteristic K Characteristic L, and Characteristic M may qualify for a given outcome code which is quite specific and quite attractive to clients. An outcome from a different pass which includes same value for Characteristic K, a different values for Characteristic L, and same value for Characteristic M may only compare favorably for Characteristics K and M. The outcomes will differ for these two passes, but will be within a group of codes which describe the general scenario. The former one will have a better assessment within the group. A third pass may be generated based on Characteristic K only, and a fourth pass based on Characteristic Z. Positive outcomes for the 3rd and 4^{th} passes may be assigned a descriptive code for a completely different group since they imply scenarios which are quite different from those assigned to the first two passes. The client specifies their priorities and that specification is used to rank the outcomes.

FIG. 7A is a revised version of a conventional system and method for searching and matching databases (see U.S. Pat. No. 7,392,240, incorporated herein in its entirety). The purpose of this diagram is to highlight enhancement over a conventional system such as that disclosed in U.S. Pat. No. 7,392,240. Revisions to the original diagram focus on two areas. Pass generation system 168 represents the present disclosure described in detail elsewhere including activities such as client inquiry providing multiple versions of the same type of indicia, generating multiple sets of indicia where each includes up to one version of each specific indicia, then generating a pass for each of those combinations. System 168 shows that each of those passes interacts in parallel through one of the protocol adapters 170 and 172, respectively. Once all the multiple passes are complete, the outcomes are evaluated as a set, enabling adjustment or promotion of outcome codes, ranking of outcomes based on precedence information, and final choice of winning outcome. Regardless of online or batch protocol adapter, the orchestration waits for the last of all passes to complete, so the complete set can be considered. The present disclosure generates additional passes based on the outcome of prior passes.

As described above, system 168 is in communication with online and batch protocol adapters 170, 172 which receive online requests (IR) and batch requests (IR), respectively. These requests are sent to pre-processing layer 174 where they are processed in a pre-processing layer listener/acceptor processor 176, queue 178 and cleaning, parsing and standardize processor 180. The cleaned, parsed and standardized data is then either transmitted to sender 182 or first level caching system 184. If sent to system 184 then the information is then processed via output gatherer/separator 186 and then delivered to reporter 188. If sent to sender 182, then it proceeds to application layer 190 where it is processed by application layer listener/acceptor 192, queue 194 and match strategy 196. Match strategy 196 includes key construction 198, measurement 200, and evaluation and decision 202.

Evaluation and decision 202 of the conventional system evaluates/decides prior granular indicia assessments, and together with the present disclosure, it also creates an initial simplified (multi-indicia) codification describing the outcome. In addition to system 168 and its interaction with the batch and online protocol adapters (170, 172), FIG. 7A shows there is enhancement to conventional systems within the evaluate and decide phase. The enhancement to evaluate/decide is shown as item 10 or 202 on FIG. 7A, and is shown in the callout as 24A, i.e., initial simplified (multi-indicia) codification of outcome. Following existing evaluate activities for the pass. granular match insight set by a conventional system is evaluated across indicia. Based on the granular match insight and some additional assessment, outcome codes are assigned. The outcome codes describe multiple factors useful to a client in interpreting results, and for prioritization of results from the various passes.

The expanded match insight, including the additional initially assigned outcome code, is passed along via output sender 220 to output listener 222.

FIGS. 8 and 8A is a chart according to the present disclosure with an example of steps 6 and 7a) from FIG. 3 which identifies opportunity to promote some outcome codifications based on outcome of other passes, and considers the received precedence information and the codified outcome of each permutation/pass, and choose the best one for the client.

FIG. 8.1 is a chart according to another version of the present disclosure shown in FIG. 8 with a common Related Record ID which indicates the two different records

(Record IDs) returned by passes 1 and 10 that are sufficiently related to support a Reinforcement conclusion. Similarly, a Related Record ID which is the same as a Record ID returned by a different pass may qualify as reinforcement. Variations of reinforcement may be used to justify differing promotions. Moreover, FIG. 8.1 shows Reinforcement through reference to a common attribute indicating the two different records returned by two passes are sufficiently related to justify Reinforcement to have occurred.

FIG. 9 is a chart according to the present disclosure with an example of step 7b) from FIG. 3 which does this ranking activity to choose the best outcome for the client with the ability to presume the client intent where specific codes have not been specified by them. This approach enables the capability to evolve without requiring all clients to specifically embrace every possible outcome (e.g., enable maturation of granularity in codifying and prioritizing outcomes for clients, while not forcing all clients to take advantage of such maturation).

Referring to FIG. 9, if client has not embraced new granular variations of code S2, and their Precedence Profile specifies:
Q1, S1, S2, Q2, Q3, S3, P1, P2
Then:
   1. Winning pass is Pass 5, which has same precedence as Pass 7, and lower pass number.
   2. They were not harmed by the addition of more granular insight.
   3. Both S2 “variations” used same precedence position as S2 which was specified by the client.

However, if client embraces new granular variations of code S2, and specifies Precedence Profile:
Q1, S1, S2.1, Q2, S2.2, Q3, S3, P1, P2
Then:
   1. Winning pass is Pass 7, which has higher precedence than Pass 5.
   2. They chose greater control of the ultimate result.

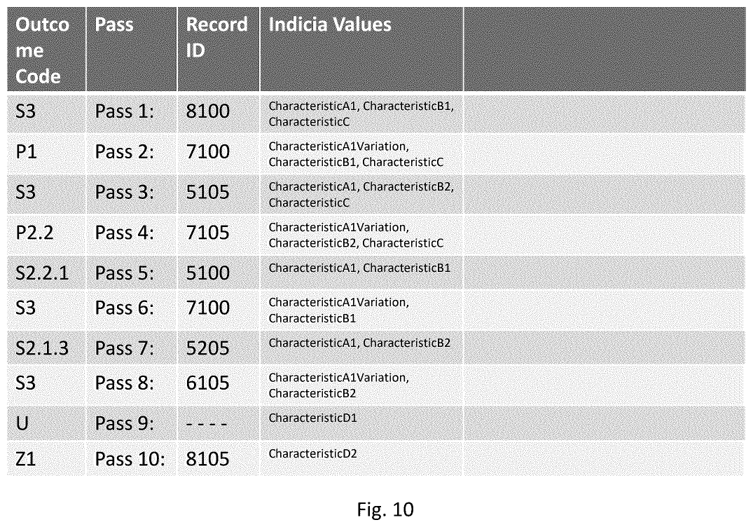

FIG. 10 is a chart according to the present disclosure with an example of step 7b) from FIG. 3 similar to FIG. 9 above with different winning pass.

Referring to FIG. 10, do this with the ability to presume the client intent where specific codes have not been specified, by them in advance, enabling the capability to evolve without requiring all clients to specifically embrace every possible outcome. Enable maturation of granularity in codifying and prioritizing outcomes for clients, while not forcing all clients to take advantage of such maturation. Default announced as new code Z1 defaults to declining ranked list: (Q3, Q2, S2, Q1).

Referring further to FIG. 10, if Precedence Profile specifies:
Q1, S1, S2, Q2, S3, P1, P2
Then:
   1. The relative precedence for Z1 would be immediately after Q2, since client precedence profile omits Z1 and Q3, but includes Q2, the second in the announced ranked list.
   2. Winning pass is still Pass 5, since profile specifies S2 prior to Q2, and Z1 would follow Q2.

However, if Precedence Profile:
Q2, S1, S2, Q3, S3, P1, P2
Then:
   1. The relative precedence for Z1 would be immediately after Q3, since client precedence profile omits Z1 and includes Q3.
   2. Winning pass is still Pass 5, since there was no Q2 or S1 outcome.

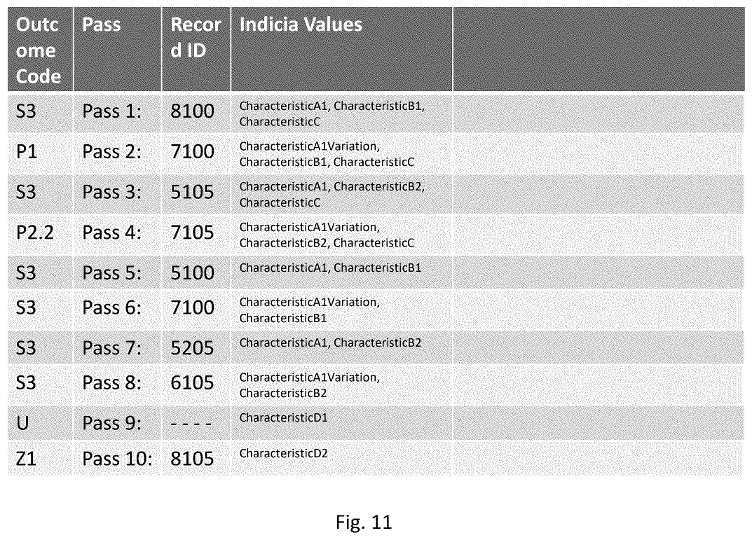

FIG. 11 is a chart according to the present disclosure with an example of step 7b) from FIG. 3 similar to FIG. 9 above with different winning pass.

Referring to FIG. 11, do this with the ability to presume the client intent where specific codes have not been specified, enabling the capability to evolve without requiring all clients to specifically embrace every possible outcome. Enable maturation of granularity in codifying and prioritizing outcomes for clients, while not forcing all clients to take advantage of such maturation. Default announced as new code Z1 defaults to declining ranked list: (Q3, Q2, S2, Q1).

Referring further to FIG. 11, if Precedence Profile specifies:
Q1, S1, S2, Q2, S3, P1, P2
Then:
   1. The relative precedence for Z1 would be immediately after Q2, since client precedence profile omits Z1 and Q3, but includes the second in the announced ranked list.
   2. Winning pass is Pass 10, since profile specifies Q2 higher than S3, P1, and P2.

FIG. 12 is a chart according to the present disclosure with an example of step 8) from FIG. 3 which adds the stewardship decision specified by the customer for this outcome.

FIG. 13 is a chart according to the present disclosure with an example of step 9) from FIG. 3 which captures the outcome of all requests, the ultimate decision/result, and the customer intent as experiential data. See the end to end description of FIG. 2.

FIG. 14 is a logic flow diagram according to the present disclosure with an example of step 10) from FIG. 3 which leverages stewardship intent when considering tuning enhancements and use as training data to inform additional candidate retrieval and decisioning methods to enable an ever-improving process. See the end to end description of FIG. 2. In addition, requests 30 are sent to core searching and matching database 24 for continuously maturing intent. The continuously maturing intent informs additional candidate retrieval and decisioning methods, and then is forwarded to experiential data 40, wherein it generates assessment of automated and heuristic potential tuning changes 42, model development for targeted data improvement campaigns 44, and use as training data to identify additional candidates and/or decisioning adjustments 46. This cycle can be recursive wherein the information from 42, 44, and 46 are returned via data and process enrichment step 41 to core searching and matching database 24 before a response 31 is returned to the client or user.

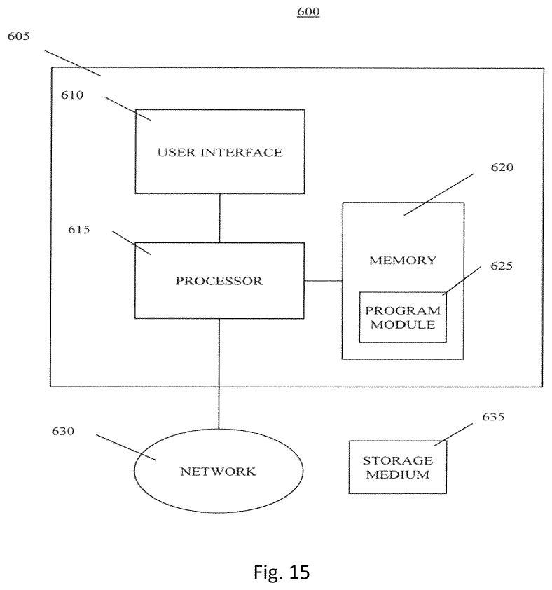

FIG. 15 is a block diagram of a system 600, for employment of the present disclosure. System 600 includes a computer 605 coupled to a network 630, e.g., the Internet.

Computer 605 includes a user interface 610, a processor 615, and a memory 620. Computer 605 may be implemented on a general-purpose microcomputer. Although computer 605 is represented herein as a standalone device, it is not limited to such, but instead can be coupled to other devices (not shown) via network 630.

Processor 615 is configured of logic circuitry that responds to and executes instructions.

Memory 620 stores data and instructions for controlling the operation of processor 615. Memory 620 may be implemented in a random access memory (RAM), a hard drive, a read only memory (ROM), or a combination thereof. One of the components of memory 620 is a program module 625.

Program module 625 contains instructions for controlling processor 615 to execute the methods described herein. For example, as a result of execution of program module 625, processor 615 performed the below method, i.e., a method for semi-automated adjudicated identity resolution comprising: seeking best match entity candidates via a core capabilities stage for the identity resolution wherein the core capabilities are is called multiple times in parallel, providing differing subsets of the full inquiry indicia received from client, such that a large number of possible outcomes can be observed depending on which inquiry indica are used in combination with others; and assigning an initial outcome code for the resulting winner for each pass; wherein the initial outcome code may later be promoted or improved when considered in conjunction with the outcome of one or more other pass outcomes. Stewardship intent is monitored and, in the event an “accept” outcome is not initially found, the system recursively leverages the most positive results of prior attempts and generates additional passes in an effort to find a more acceptable outcome. Interim and eventual results are all experiential data and are captured for multiple uses including, but not limited to, tuning methods, input to AI methods for tuning, and informs downstream discovery and curation processes. Thus, program module 625 may be implemented as a single module or as a plurality of modules that operate in cooperation with one another. Moreover, although program module 625 is described herein as being installed in memory 620, and therefore being implemented in software, it could be implemented in any hardware (e.g., electronic circuitry), firmware, software, or a combination thereof.

User interface 610 includes an input device, such as a keyboard or speech recognition subsystem, for enabling a user to communicate information and command selections to processor 615. User interface 610 also includes an output device such as a display or a printer. A cursor control such as a mouse, trackball, or joystick, allows the user to manipulate a cursor on the display for communicating additional information and command selections to processor 615.

Processor 615 outputs, to user interface 610, a result of an execution of the methods described herein. Alternatively, processor 615 could direct the output to a remote device (not shown) via network 630.

While program module 625 is indicated as already loaded into memory 620, it may be configured on a storage medium 635 for subsequent loading into memory 620. Storage medium 635 can be any conventional storage medium that stores program module 625 thereon in tangible form. Examples of storage medium 635 include a floppy disk, a compact disk, a magnetic tape, a read only memory, an optical storage media, universal serial bus (USB) flash drive, a digital versatile disc, or a zip drive. Alternatively, storage medium 635 can be a random access memory, or other type of electronic storage, located on a remote storage system and coupled to computer 605 via network 630.

An alternative embodiment pertains to when an assigned outcome code is not specified, a series of methods used to anchor the assigned code to one which has been specified. Such methods include leveraging maximized partial commonality of the outcome code which has been specified by the client. These approaches may be used for both precedence and stewardship, as well as any future customization-enabled features which may be made available.

Ensure calling client applications are built to be easily upgraded as the capability matures. This includes things such as:
a. Precedence Configuration—this profile is sent with each request and is customized to needs of the use case/scenario.
b. Stewardship Configuration—this is also sent with each request. It's used to customize the desired stewardship such as routing appropriately.
c. Accept unrecognized outcome codes and extract or infer a recognized code from a received code.
d. Anticipate that newer/not-yet-configured outcome codes will be treated similarly to similar configured codes.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method for semi-automated adjudicated identity resolution comprising:
seeking best match entity candidates via a core capabilities stage for said identity resolution for a single pass using enhanced core capabilities, via the following steps:
a. cleansing, parsing, and standardizing data;
b. retrieving candidates from said standardized data; and
c. evaluating granular indicia to decide the best match of said candidates; and
extending said core capabilities stage with an attribution stage, which assigns a multi-indicia assessment of said retrieved and evaluated candidates, by leveraging the granular indicia assessments; wherein said multi-indicia assessments are grouped by related or similar yet distinct scenarios.

2. The method of claim 1, wherein said distinct scenarios are at least one selected from the group consisting of:
scenarios which include several of the same indicia performing well, but not others;
scenarios which are based on how well one or more key indicia performed; and
combinations thereof.

3. A method for semi-automated adjudicated identity resolution comprising:
seeking best match entity candidates via a core capabilities stage for said identity resolution wherein said core capabilities are called multiple times in parallel, providing differing subsets of the full inquiry indicia received from client, such that a large number of possible outcomes can be observed depending on which inquiry indica are used in combination with others; and assigning an initial outcome code for the resulting winner for each pass; wherein said initial outcome code may later be promoted or improved when considered in conjunction with the outcome of one or more other pass outcomes.

4. The method according to claim 3, wherein said outcome codes may eventually be reassigned outcome codes reflecting reinforcement by combining information from multiple pass winners or other independently assessed information from the inquiry compared to the returned record to assign or promote a more positive outcome code to one or more pass outcome.

5. The method according to claim 4, wherein said information from multiple pass winners may include the return of the same record by more than one pass, or said information on passes which confirms that the return records are sufficiently related to each other to reinforce one another.

6. The method according to claim 3, further uses use-case and user specific priorities to direct the choice of an ultimate winning outcome from said winner for each one of several passes.

7. The method according to claim 3, wherein the use of said outcome codes for each of the singular winning pass outcomes, and precedence specified by clients for determining specific outcome codes over other outcome codes.

8. The method according to claim 6, further using stewardship intent information to assign stewardship decisions to said pass winners and to the ultimate winning outcome.

9. A method that semi-automatically adjudicates identity resolution, said method comprising:
receiving inquiry attributes describing a sought after entity;
receiving user preferences and intent related to said sought after entity;
combining said inquiry attributes, said user preferences, and intent;
passing the combined said inquiry attributes, said user preferences, and user intent between 1 to n times, with inquiry data which varies across the multiple passes;
transmitting said generated inquiry data to a searching and matching database which recursively passes said generated inquiry data in parallel until need and opportunity have been exhausted;
determining an initial simplified codification of an outcome from each said pass;
identifying reinforcement outcomes from each said pass and recodifying said reinforced outcomes;
for the purpose of determining precedence and intent where client has not specified that information for a given outcome code which has occurred, anchoring unspecified codes to specified codes by leveraging partial commonality of code values with specified codes, followed, if necessary, by the use of communicated and configured pairings among possible codes;
assigning intent based on ultimately assigned code per instance;
capturing a copy of experiential data about each pass including but not limited to specific inquiry indicia used, identified entity and its attributes, granular indicia assessments, multi-indicia (outcome) assessment, and client intent for this multi-indicia assessment;
determining whether sufficient passes have been attempted to yield dispositive results and optionally generating and executing additional passes, generating additional—outcomes;
once dispositive results are achieved or possible passes exhausted, ranking actual outcomes based on the ultimately assigned multi-indicia outcome codes in concert with the originally specified prioritization of said possible outcomes; and
returning a winning outcome and intent as identified by a top ranked pass.

10. A method of capturing experiential data, interim and eventual results, as input to tuning methods including artificial intelligence, plus informing downstream discovery and curation processes to support targeted improvements of a corpus of data, thereby continually improving future outcomes.

11. A computer operated system comprising a processor and a memory with a program module that contains instructions for controlling said processor to execute a method for semi-automated adjudicated identity resolution comprising:
seeking best match entity candidates via a core capabilities stage for said identity resolution for a single pass using enhanced core capabilities, via the following steps:
a. cleansing, parsing, and standardizing data;
b. retrieving candidates from said standardized data; and
c. evaluating granular indicia to decide the best match of said candidates; and
extending said core capabilities stage with an attribution stage, which assigns a multi-indicia assessment of said retrieved and evaluated candidates, by leveraging the granular indicia assessments; wherein said multi-indicia assessments are grouped by related or similar yet distinct scenarios.

12. The system of claim 11, wherein said distinct scenarios are at least one selected from the group consisting of:
scenarios which include several of the same indicia performing well, but not others;
scenarios which are based on how well one or more key indicia performed; and
combinations thereof.
